(19) United States
(12) Patent Application Publication
(10) Pub. No.: US 2022/0219742 A1
(43) Pub. Date: Jul. 14, 2022

(54) METHOD AND DEVICE FOR PROTECTING WHEELSETS AND A RAILROAD BED FROM WEAR

(71) Applicant: KUPPER SERVIS, LLC, Moscow (RU)

(72) Inventors: Sergey M. Mamykin, Moscow (RU); Dmitry V. Privalov, Moscow (RU)

(21) Appl. No.: 17/612,252

(22) PCT Filed: Apr. 3, 2020
(86) PCT No.: PCT/RU2020/000181

§ 371 Date: Nov. 18, 2021

(30) Foreign Application Priority Data
Dec. 15, 2019 (RU) 2019141598

(51) Int. Cl. B61K 3/02; F16N 7/30; B05D 1/02

(52) U.S. Cl. CPC B61K 3/02; B05D 1/02; F16N 7/30

(57) ABSTRACT

The invention relates to the field of rail transport. The present method for protecting wheelsets and a railroad bed from wear consists in applying, for the purpose of protecting coupling components under mutual friction from wear, an anti-wear coating that consists of ductile metals in the form of films on the frictional surface of said coupling components. A device for controlling the supply of a metal-plating ionisation solution emits a signal for activating or deactivating an electromagnetic valve mounted on a heated air duct connected to a reservoir that contains said metal-plating ionisation solution. The advantages of the present invention consist in more effectively protecting working surfaces from mechanical and hydrogen wear.

### TECHNICAL FIELD

The invention relates to the field of rail transport and may be used to increase the wear resistance of parts of a friction set of a wheel/rail coupling of rail transport.

### DESCRIPTION OF PRIOR ART

From the “Prior Art”, a method of increasing the wear resistance of the rolling surface of a wheelset is known, which is based on applying a coating that consists of a ductile copper-containing metal on the rolling surface. To prevent hydrogen wear of the rolling surface during the rotation of a wheelset, the rolling surface is first moistened in a liquid technological medium based on water and glycerol with the inclusion of ductile metal salts, and then a processing tool made of said metal is brought into contact with the rolling surface under a force, the magnitude of which causes a whistling sound, indicating the transfer of the tool metal to the treated surface, which, at the end of the process, is washed using a 5% solution of glycerol in water (Russian Federation Patent No. 2112663, Class B60B 17/00, published on 10 Jun. 1998).

In addition, from the “Prior Art”, a method of applying a coating that consists of ductile metals on the frictional surface of coupling components, for example, of a wheel/rail coupling, is known, which is based on applying an anti-wear coating in the dynamics of motion. For the purpose of restoring the wear of coupling components under mutual friction, an anti-wear coating that consists of ductile metals in the form of films with a thickness of 1.0-1.5 μm is simultaneously applied on the frictional surface of said coupling components by the selective transfer of ductile metal ions on the contacting surfaces of the components from the volume of the metal-plating ionisation solution located in the friction zone that contains, in the form of ions, up to 10% of the mass fraction of the applied composition that consists of ductile metals, uniformly distributed in the rest of the mass of liquid components having surface-active and reducing properties. In this case, the solution, depending on the pressure arising in the friction zone of coupling components, is supplied according to the intermittent or continuous injection scheme (Russian Federation Patent No. 2283702, Class B05D 1/04, published on 20 Sep. 2006).

From the “Prior Art”, a device for applying a coating that consists of ductile metals on the frictional surface of coupling components, for example, a wheel/rail coupling, is known, placed on the frames of the transport and the wheelset bogie and containing an inlet pneumatic valve, connected to the pneumatic line and to the electrical circuit of the transport control panel, a reservoir that contains the metal-plating ionisation solution, connected, by a pneumatic pipe, with the inlet pneumatic valve, an operating pneumatic valve, connected, through a throttle, to the inlet pneumatic valve and the electrical connection to the control unit for the passage of a programmed distance and switch-on time interval, a regulator including a pneumatic cylinder that contains a spring-loaded piston. It also includes an annular chamber, connected to the outlet of the reservoir duct and the inlet of the sprayer duct for ensuring the supply of the metal-plating ionisation solution through the duct and the injection, by the sprayer, of the metal-plating ionisation solution into the friction zone of coupling components, an auxiliary chamber, connected to the outlet of the reservoir duct, and the main chamber, connected to the inlet of the sprayer duct, a spring-loaded valve with lower and upper rods placed between them, a weathervane made with the possibility of contact with the lower rod, installed, with the support part, via a spring-loaded driving washer, into the regulator right support and, with the operating part, into its left support, which, by the force of the spring, maintains constant contact with the vertical plane of the bogie frame, while the sprayer is installed on the bogie frame (Russian Federation Patent No. 2283702, Class B05D 1/04, published on 20 Sep. 2006).

The technical problem is that the known methods do not prevent wear caused by mechanical wear and the release of hydrogen in the friction zone, namely the process of wear of metals in the frictional contact zone, where the mechanisms of hydrogen embrittlement in the microlayers of frictional interaction during the diffusion of hydrogen from the metal volume into the zone of frictional interaction are the determining factors. Limiting the operation of the device for protecting wheelsets and a railroad bed from wear, depending on the ambient temperature, especially under the conditions of the North.

### General Disclosure of the Invention

The task of the present group of inventions is to eliminate the above disadvantages.

The generalised technical result consists in more effectively protecting working surfaces from mechanical and hydrogen wear and ensuring the operation of the device at various ambient temperatures (−60° C.-+50° C.).

The technical result is provided by the fact that the method for protecting wheelsets and a railroad bed from wear consists in applying, for the purpose of protecting coupling components under mutual friction from wear, an anti-wear coating that consists of ductile metals in the form of films on the frictional surface of said coupling components by the selective transfer of ductile metal ions on the contacting surfaces of the components from the volume of the metal-plating ionisation solution located in the friction zone. In this case, the solution, depending on the pressure arising in the friction zone of coupling components, is supplied according to the intermittent or continuous injection scheme. A device for controlling the supply of a metal-plating ionisation solution emits a signal for activating or deactivating an electromagnetic valve mounted on a heated air duct connected to a reservoir that contains the metal-plating ionisation solution. When the electromagnetic valve is activated, the heated air enters through the branched duct into the reservoir that contains the metal-plating ionisation solution and into the nozzles. The metal-plating ionisation solution, under air pressure, is supplied from the reservoir that contains the metal-plating ionisation solution into a tube passing through the heated air duct with a branch to each nozzle. In the nozzle bodies, the heated air is mixed with the metal-plating ionisation solution, and an air-liquid medium is supplied to the side inner edge of the head of the outer rail in the corresponding track curve by spraying it in the area where the wheel tyre cone diameter is equal to D₂ and to the head of the inner rail in the corresponding track curve by spraying it in the area where the wheel tyre cone diameter is equal to D₁, while D₂>D₁.

The technical result is also provided by the fact that the device for protecting wheelsets and a railroad bed from wear is placed on the frames of the transport and the wheelset bogie and contains a reservoir that contains the metal-plating ionisation solution, connected, by a tube, with nozzles that are installed on the bogie frame for ensuring the supply and injection of the metal-plating ionisation solution into the friction zone of the coupling components. It has a heated reservoir for storing air in it under a pressure of approximately 8 atm, an electromagnetic valve installed on a heated air duct, which has branches and connects, with one of its branches, the heated reservoir with the reservoir that contains the metal-plating ionisation solution and, with the two other branches, with the nozzles for ensuring the supply and injection of the metal-plating ionisation solution into the friction zone of the coupling components. In addition, the device has a tube that enables the supply of the metal-plating ionisation solution from the reservoir that contains the metal-plating ionisation solution into the nozzles through calibrated orifices made inside the nozzles, and passes through the heated air duct with a branch to each nozzle. The nozzles are made with the possibility of mixing the heated air with the metal-plating ionisation solution in their bodies and supplying an air-liquid medium to the side inner edge of the head of the outer rail in the corresponding track curve by spraying it in the area where the wheel tyre cone diameter is equal to D₂ and to the head of the inner rail in the corresponding track curve by spraying it in the area where the wheel tyre cone diameter is equal to D₁, while D₂>D₁.

### BRIEF DESCRIPTION OF THE DRAWINGS

FIG. 1 shows the general diagram of the device;

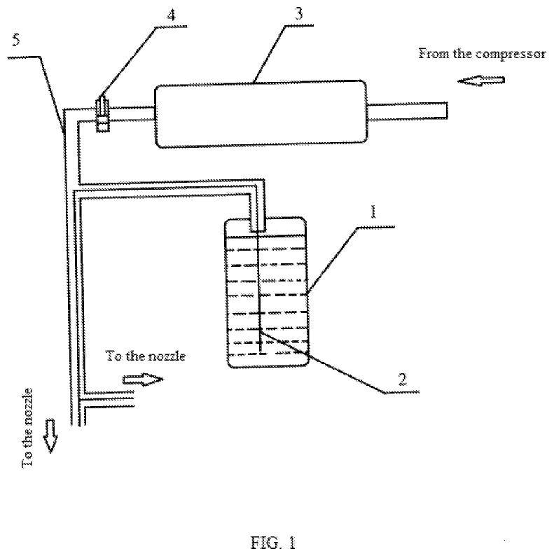

FIG. 2 is the block diagram featuring the configuration of the device control system;

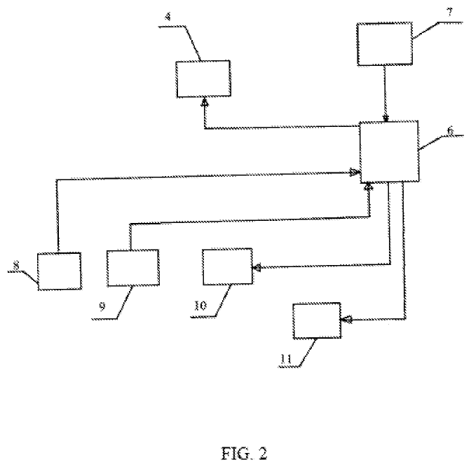

FIG. 3 shows a wheel flange of a wheelset;

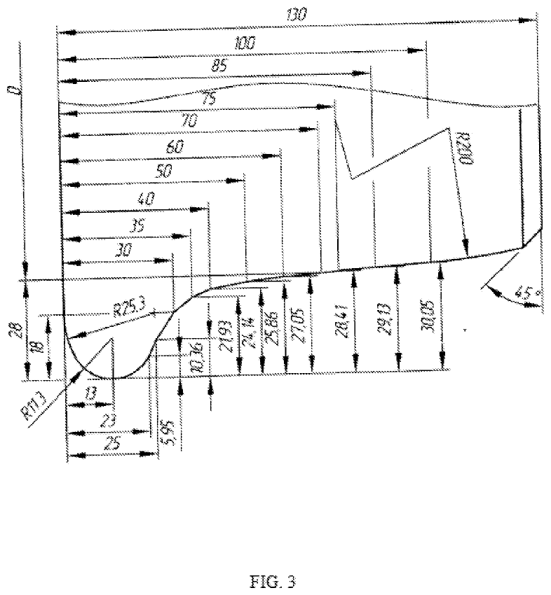

FIG. 4 shows the position of a wheelset in the curve.

### THE BEST MODE OF CARRYING OUT THE INVENTION

A device for protecting wheelsets and a railroad bed from wear is placed on the frames of the transport and the wheelset bogie and contains Reservoir that Contains the Metal-Plating Ionisation Solution 1, connected, by Tube 2, with nozzles that are installed on the bogie frame for ensuring the supply and injection of the metal-plating ionisation solution into the friction zone of the coupling components. It has Heated Reservoir for Storing Air 3 in it under a pressure of approximately 8 atm (preferably 8 atm), Electromagnetic Valve 4 installed on Heated Air Duct 5, which has branches and connects, with one of its branches, Heated Reservoir 3 with Reservoir that Contains the Metal-Plating Ionisation Solution 1 and, with the two other branches, with the nozzles for ensuring the supply and injection of the metal-plating ionisation solution into the friction zone of the coupling components. In addition, the device has Tube 2 that enables the supply of metal-plating ionisation solution from Reservoir that Contains the Metal-Plating Ionisation Solution 1 into the nozzles through calibrated orifices made inside the nozzles and passes through Heated Air Duct 5 with a branch to each nozzle. The nozzles are made with the possibility of mixing the heated air with the metal-plating ionisation solution in their bodies and supplying an air-liquid medium to the side inner edge of the head of the outer rail in the corresponding track curve by spraying it in the area where the wheel tyre cone diameter is equal to D₂ and to the head of the inner rail in the corresponding track curve by spraying it in the area where the wheel tyre cone diameter is equal to D₁, while D₂>D₁.

The method for protecting wheelsets and a railroad bed from wear consists in applying, for the purpose of protecting coupling components under mutual friction from wear, an anti-wear coating that consists of ductile metals in the form of films with a thickness of 1.0-1.5 μm on the frictional surface of said coupling components by the selective transfer of ductile metal ions on the contacting surfaces of the components from the volume of the metal-plating ionisation solution located in the friction zone that contains, in the form of ions, up to 10% of the mass fraction of the applied composition that consists of ductile metals, uniformly distributed in the rest of the mass of liquid components.

In this case, the solution, depending on the pressure arising in the friction zone of coupling components, is supplied according to the intermittent or continuous injection scheme. Device for Controlling the Supply of a Metal-Plating Ionisation Solution 6 emits a signal for activating or deactivating Electromagnetic Valve 4 mounted on Heated Air Duct 5 connected to the reservoir that contains the metal-plating ionisation solution.

Valve 4 is activated and deactivated by a servo drive (not shown in the figure), which is controlled by Control Device 6 and Unit 7 for determining the position of the means of transportation in relation to the beginning and end of a curved section of a railway track. Economical lubrication of rails and wheels of the means of transportation for reducing the wear of contacting sets is only carried out in this section. The lubrication system of this device may be automatically controlled using commands sent by the GLONASS global navigation system or by means of a computer, the hardware and software system of which contains programmed sections of a straight section of a rail track. The frequency of activating and deactivating Valve 4 allows for intermittent or continuous injection.

Control Device 6 receives a signal from Air Temperature Sensor 8 in Heated Air Storage Reservoir 3. When the air temperature in Reservoir 3 is 35° C., the heater is activated by moving Heater Switch 10 to the ‘on’ position using a servo drive, and when the air temperature is 75° C., the switch is turned off. In addition, Control Device 6 receives a signal from Air Pressure Sensor 9 in Heated Air Storage Reservoir 3. When the air pressure in Reservoir 3 is less than 8 atm (7.5-7.8 atm), the locomotive compressor is activated by moving Compressor Switch 11 to the ‘on’ position using a servo drive. In addition, the device may provide a metal-plating ionisation solution level sensor in Reservoir 1.

When Electromagnetic Valve 4 is activated, the heated air enters through Branched Duct 5 into Reservoir that contains the Metal-Plating Ionisation Solution 1 and into the nozzles. The metal-plating ionisation solution, under air pressure, is supplied from Reservoir that Contains the Metal-Plating Ionisation Solution 1 into Tube 2 passing through Heated Air Duct 5 with a branch to each nozzle. In the nozzle bodies, the heated air is mixed with the metal-plating ionisation solution, which is supplied through a calibrated orifice made inside the nozzle. The heated air enters each nozzle through Duct 5, the branches of which are connected to the nozzle bodies. An air-liquid medium is supplied to the side inner edge of the head of the outer rail in the corresponding track curve by spraying it in the area where the wheel tyre cone diameter is equal to D₂ and to the head of the inner rail in the corresponding track curve by spraying it in the area where the wheel tyre cone diameter is equal to D₁, while D₂>D₁.

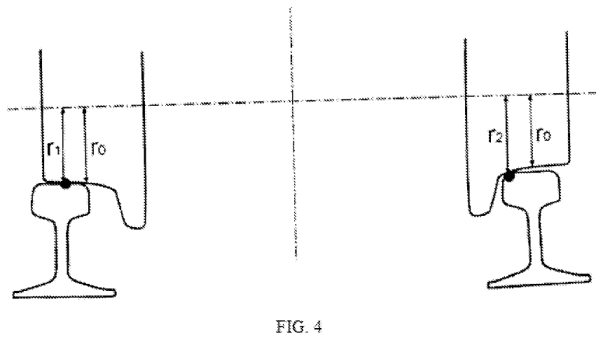

A wheelset should be seen as a whole; therefore, the angular speed of rotation of both wheels is always the same when moving in curves. Wheel one (see FIG. 4), due to centrifugal force, is tightly pressed against the side edge of the outer rail, wherein the diameter of the wheel is maximal in this area; while, at this moment, wheel two rolls on the inner rail having the minimal diameter. At this time, the anti-wear coating is supplied to the zones where the wheel contact with the rail occurs, namely, into the base of the wheel flange pressed against the rail and to the middle of the tyre of wheel two.

### INDUSTRIAL APPLICABILITY

The invention may be used in the field of railway transport. The advantages of the present group of inventions are as follows:
protecting working surfaces from “hydrogen wear”, which is the main factor causing wear;
the absence of lubricants in the technological environment excludes any possibility of the adhesion of abrasives and reduces the likelihood of slipping at the moment of starting and going up hills;
all-season system operation: application temperature range is −60° C.-+50° C.;
improving the braking process, extending the service life of brake blocks;
extending the service life of working surfaces of rails and the wheelsets of a locomotive, as well as of cars following it;
environmental safety: there are no oil products in the technological environment;
one filling is enough for ensuring the mileage between current repairs of TR-1.

1. The method for protecting wheelsets and a railroad bed from wear that consists in applying, for the purpose of protecting coupling components under mutual friction from wear, an anti-wear coating that consists of ductile metals in the form of films on the frictional surface of said coupling components by the selective transfer of ductile metal ions on the contacting surfaces of the components from the volume of the metal-plating ionisation solution located in the friction zone, wherein the solution, depending on the pressure arising in the friction zone of the coupling components, is supplied according to the intermittent or continuous injection scheme, characterised in that a device for controlling the supply of a metal-plating ionisation solution emits a signal for activating or deactivating an electromagnetic valve mounted on a heated air duct connected to a reservoir that contains the metal-plating ionisation solution; when the electromagnetic valve is activated, the heated air enters through the branched duct into the reservoir that contains the metal-plating ionisation solution and into the nozzles; the metal-plating ionisation solution, under air pressure, is supplied from the reservoir that contains the metal-plating ionisation solution into a tube passing through the heated air duct with a branch to each nozzle; in the nozzle bodies, the heated air is mixed with the metal-plating ionisation solution, and an air-liquid medium is supplied to the side inner edge of the head of the outer rail in the corresponding track curve by spraying it in the area where the wheel tyre cone diameter is equal to D₂ and to the head of the inner rail in the corresponding track curve by spraying it in the area where the wheel tyre cone diameter is equal to D₁, while D2>D₁.

2. A device for protecting wheelsets and a railroad bed from wear, which is placed on the frames of the transport and the wheelset bogie and contains a reservoir that contains the metal-plating ionisation solution, connected, by a tube, with nozzles that are installed on the bogie frame for ensuring the supply and injection of the metal-plating ionisation solution into the friction zone of the coupling components, characterised in that it has a heated reservoir for storing air in it under a pressure of approximately 8 atm, an electromagnetic valve installed on a heated air duct, which has branches and connects, with one of its branches, the heated reservoir with the reservoir that contains the metal-plating ionisation solution and, with the two other branches, with the nozzles for ensuring the supply and injection of the metal-plating ionisation solution into the friction zone of the coupling components; in addition, the device has a tube that enables the supply of metal-plating ionisation solution from the reservoir that contains the metal-plating ionisation solution into the nozzles through calibrated orifices made inside the nozzles and passes through the heated air duct with a branch to each nozzle, and the nozzles are made with the possibility of mixing the heated air with the metal-plating ionisation solution in their bodies and supplying an air-liquid medium to the side inner edge of the head of the outer rail in the corresponding track curve by spraying it in the area where the wheel tyre cone diameter is equal to D₂ and to the head of the inner rail in the corresponding track curve by spraying it in the area where the wheel tyre cone diameter is equal to D₁, while D₂>D₁.
